(19) United States
(12) Patent Application Publication
(10) Pub. No.: US 2006/0139139 A1
(43) Pub. Date: Jun. 29, 2006

(54) Holder device for a transformer

(76) Inventor: Jan Frode Haaland, Soegne (NO)

Correspondence Address: William B Patterson;Moser, Patterson & Sheridan, Suite 1500, 3040 Post Oak Boulevard, Houston, TX, 77056, US

(21) Appl. No.: 10/537,946

(22) PCT Filed: Dec. 10, 2003
(86) PCT No.: PCT/NO03/00411

§ 371 Date: Nov. 18, 2005

(30) Foreign Application Priority Data
Dec. 11, 2002 (NO) 20025957

(51) Int. Cl. H01F 27/30

(52) U.S. Cl. 336/205

(57) ABSTRACT

A holder device for a safety transformer (1) for use in electrical installations of extra low voltage, in which the safety transformer (1) is placed in proximity of a consumer object (2), and in which the safety transformer (1) is connected to a piece of fittings (7).

This invention concerns a transformer holder. More particularly, it concerns a holder for a transformer of the type used for step-down transforming of an ordinary mains voltage, and being placed in proximity of a consumer object, the consumer object being, for example, a lighting fixture as is common in so-called installations of extra low voltage.

Transformers of the type discussed herein usually are electronically protected apparatuses, denoted in the field as “safety transformers”, and being arranged for transforming electric voltage from an ordinary mains voltage, for example in the order of 220 to 240 Volts, and down to a lower user voltage, for example 12 Volts.

In the following, problems concerning the safety transformer are illustrated, referring to a flush-mounted, low-voltage lighting fixture, but the problems are equally relevant to other consumer objects wherein the voltage is stepped-down in proximity of the consumer object.

According to prior art, a flush-mounted, low-voltage lighting fixture may comprise a fastening device and a light bulb holder provided with a reflector. The light bulb holder may be fixedly or adjustably connected to the fastening device. During mounting, for example in a ceiling, a through-going opening is generally drilled in the ceiling panel, into which opening the fastening device fits in a complementary manner. Then the fastening device is connected to the ceiling panel by means of screws or some form of quick release coupling.

The power supply wire leading to the flush-mounted lighting fixture may be buried in a manner per se on the upper side of the ceiling. According to prior art the power supply wire is connected to the primary circuit of a loose safety transformer, while the secondary circuit of the safety transformer is connected, via conductors, to the electric connection point of the lighting fixture. After connection, the safety transformer is pushed through the opening in the ceiling panel, after which the lighting fixture is pushed into the opening and is fixed to the ceiling panel.

According to prior art, the safety transformer thus is placed loosely on the upper side of the ceiling panel.

It is proven that devices of this type may represent a fire hazard. The reason may be that the safety transformer during operation may be resting too close to the lighting fixture and does not receive sufficient cooling. After some time, the safety transformer/lighting fixture assembly thus may become hot enough to cause ignition of flammable material nearby. Another reason may be that the connecting wires between the loose safety transformer and the lighting fixture is overloaded and is damaged during the assembly work, whereby flashovers may take place between the conductors.

These conditions have resulted in tightened authority demands concerning fixing of safety transformers. The authority demands stipulate that the safety transformer is to be fixedly secured and fixedly connected to the lighting fixture.

The object of the invention is to remedy the disadvantages of prior art and to disclose a device that satisfies the authority demands.

The object is achieved in accordance with the features of the invention disclosed in the specification below and in the subsequent claims.

By connecting the safety transformer to a mounting bracket, for example in the form of a piece of fittings, in which the is piece of fittings also is connected to the ceiling or to the lighting fixture, the safety transformer may be placed at a safe distance from the lighting fixture and the ceiling panel, and simultaneously being fixedly mounted and being provided for a fixed electric connection to the lighting fixture.

The piece of fittings may have an L-form, in which one leg supports the safety transformer, while the other leg is connected to the ceiling or to the lighting fixture. Given this form, the safety transformer is located immediately above the ceiling panel, but at a suitable distance to the lighting fixture and the ceiling panel, and simultaneously the safety transformer may be removed in a relatively simple manner through the opening in the ceiling panel during replacement—and repair works.

In the following, a non-limiting example of a preferred embodiment is described and is illustrated on the appended drawings, in which:

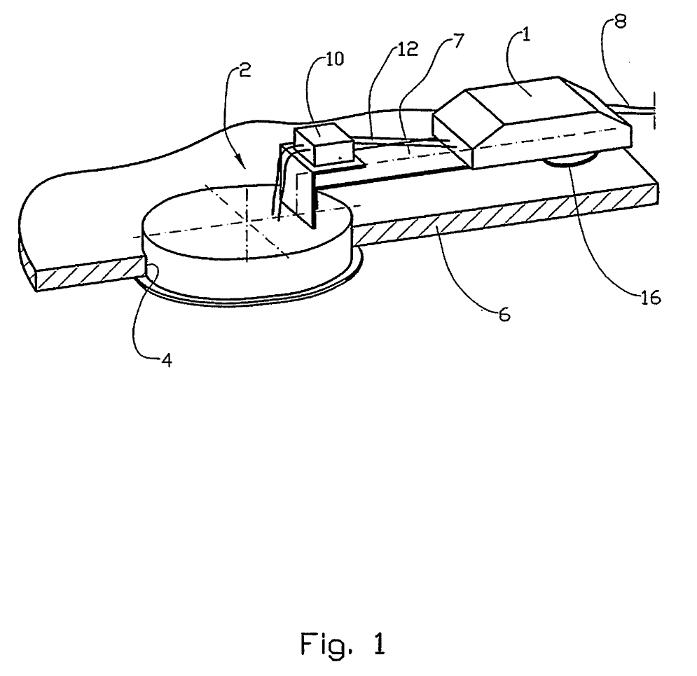

FIG. 1 shows a safety transformer being connected to a flush-mounted lighting fixture; and

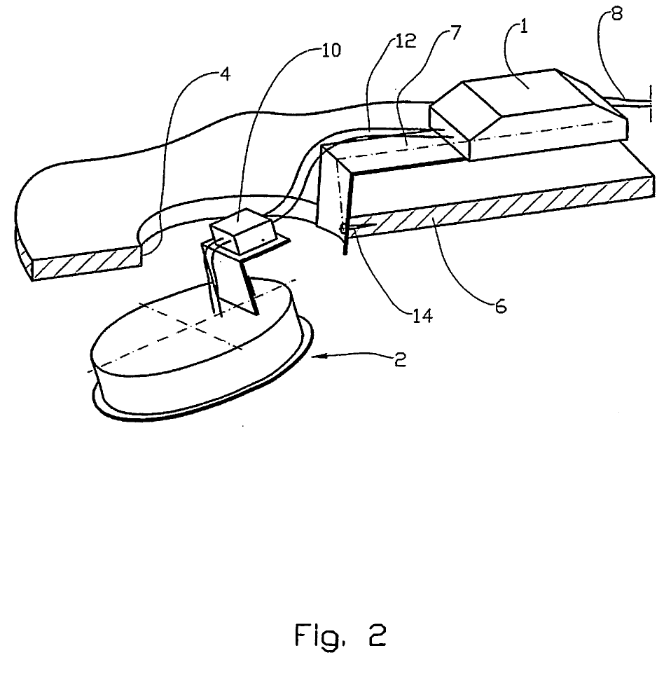

FIG. 2 shows the safety transformer connected to the ceiling panel by means of a piece of fittings while installing the lighting fixture.

On the drawings, reference numeral 1 denotes a safety transformer being connected to a flush-mounted lighting fixture 2, in which the lighting fixture 2 is placed within an opening 4 in a ceiling 6.

A piece of fittings 7 is connected to the lighting fixture 2 and to the safety transformer 1. Electric current is supplied to the safety transformer 1 through a supply wire 8 and is electrically connected to a connection point 10 of the lighting fixture 2 by means of conductors 12.

If desirable, the fittings 7 may be comprised of an associated portion protruding from the lighting fixture 2.

In an alternative embodiment, and by means of a screw 14, the piece of fittings 7 may be detachably connected to the anchoring object of the lighting fixture 2, such as the ceiling 6, cf. FIG. 2. Alternatively, the piece of fittings 7 may be connected to the ceiling 6 by means of a quick release coupling that, if desirable, may fit complementary to the lighting fixture 2.

Advantageously, the piece of fittings 7 may be provided with a portion 16 protruding towards the ceiling panel 6, cf. FIG. 1, to prevent the safety transformer 1 from unintentionally getting too close to the ceiling panel 6.

1. A holder device for a safety transformer for use in flush mounted electrical installations of extra low voltage, in which the safety transformer is placed in proximity of an electricity consumer object, the safety transformer and the electricity consumer object being detachable through a mounting aperture of an anchoring object, characterized in that the safety transformer is connected to a piece of fittings, the piece of fittings being arranged to hold the safety transformer at a distance from the electricity consumer object and the anchoring object.

2. The device according to claim 1, characterized in that the piece of fittings is connected to the electricity consumer object.

3. The device according to claim 1, characterized in that the piece of fittings is connected to the anchoring object.
